(19) United States
(12) Patent Application Publication
(10) Pub. No.: US 2024/0378260 A1
(43) Pub. Date: Nov. 14, 2024

(54) EXECUTION UNIT, PROCESSING DEVICE AND METHOD FOR APPROXIMATING A FUNCTION

(71) Applicant: Graphcore Limited, Bristol (GB)

(72) Inventors: Badreddine NOUNE, Bristol (GB); Godfrey DA COSTA, Bristol (GB); Carlo LUSCHI, Oxford (GB)

(21) Appl. No.: 18/657,191

(22) Filed: May 7, 2024

(30) Foreign Application Priority Data
May 12, 2023 (GB) 2307086.5

(51) Int. Cl. G06F 17/17; G06F 1/03

(52) U.S. Cl. CPC G06F 17/17; G06F 1/03

(57) ABSTRACT

An execution unit configured to: receive a first computer program instruction to populate a lookup table with a plurality of entries, each entry comprising an x value and corresponding y value representative of a point on a curve of a function, consecutive entries of the plurality of entries forming an interval of the function, populate a lookup table stored in a local memory associated with the execution unit with the plurality of entries, receive a second computer program instruction, the second computer program instruction indicating an input value, determine, based on the lookup table, the interval of the function in which the input value falls, and interpolate between y values of entries forming the interval to generate an output value corresponding to the input value.

### CROSS-REFERENCE TO RELATED APPLICATIONS

The present application claims priority to United Kingdom Patent Application No. GB2307086.5, filed May 12, 2023, the disclosure of which is hereby incorporated herein by reference in its entirety.

### FIELD

The present disclosure relates to an execution unit, processing device and method for approximating a function.

### BACKGROUND

Neural networks are used in the field of machine learning and artificial intelligence. Neural networks comprise arrangements of sets of nodes which are interconnected by links and which interact with each other. The principles of neural networks computations are inspired by information about how electrical stimuli convey information in the human brain. For this reason, the nodes are often referred to as neurons. Considering the neural network as a computation graph, the nodes may be also referred to as vertices, and the links between nodes may be referred to as edges. The network can take input data and certain nodes perform operations on the data. The result of these operations is passed to other nodes. The output of each node is referred to as its activation or node value. Each link is associated with a weight. A weight defines the connectivity between nodes of the neural network. Many different techniques are known by which neural networks are capable of learning, which takes place by altering values of the weights.

FIG. 1A shows an extremely simplified version of one arrangement of nodes in a neural network to illustrate certain relevant concepts. This type of arrangement is often used in learning or training and comprises an input layer of nodes, one or more hidden layer of nodes and an output layer of nodes. In reality, there will be many nodes in each layer, and nowadays there are typically many hidden layers, with current deep learning models for image and language processing including large numbers of layers. Each node of the input layer Ni is capable of producing at its output an activation or node value which is generated by carrying out a nonlinear function or activation function on data provided to that node. A vector of node values from the input layer is scaled by a vector of respective parameters or weights at the input of each node in the hidden layer, each weight defining the connectivity of that particular node with its connected node in the hidden layer. In practice, networks may have millions or billions of nodes and be connected multi-dimensionally, so the vector is more often a tensor. The weights applied at the inputs of the node Nₕ are labelled w0 . . . w2. In the example of FIG. 1A, each node in the input layer is connected at least initially to each node in the hidden layer. Each node in the hidden layer can perform an activation function on the data which is provided to them and can generate similarly an output vector which is supplied to each of the nodes N₀ in the output layer N₀. This is an example of a fully connected architecture or FeedForward Network (K. Hornik, M. Stinchcombe, and H. White, “Multilayer Feedforward Networks are Universal Approximators”, Neural Networks, vol. 2, pp. 359-366, 1989)—various other types of architectures have been developed over the years, including convolutional architectures (Y. LeCun, K. Kavukcuoglu, and C. Farabet, “Convolutional networks and applications in vision,” Proceedings of 2010 IEEE International Symposium on Circuits and Systems, Paris, France, pp. 253-256, 2010) and Transformer models including self-attention layers (A. Vaswani, N. Shazeer, N. Parmar, J. Uszkoreit, L. Jones, A. N. Gomez, L. Kaiser, and I. Polosukhin, “Attention is All You Need”, arXiv preprint, arXiv:1706.03762 [cs.CL], 2017).

Each node weights its incoming data, for example by carrying out the dot product of the input activations of the node and its unique weights for the respective incoming links. It then performs an activation function on the weighted data. The activation function can be for example a sigmoid or a hyperbolic tangent. See FIG. 1B. More recently used activation functions include the Rectified Linear Unit (ReLU) and the Gaussian Error Linear Unit (GeLU). The network learns by operating on data input at the input layer, assigning weights to the activations from each node and acting on the data input to each node in the hidden layer by weighing it and performing the activation function. Thus, the nodes in the hidden layer operate on the weighted data and supply outputs to the nodes in the output layer. Nodes of the output layer may also assign weights to their edges, which are used to generate output node values. There are different learning approaches, but in each case there is a forward propagation through the network from left to right in FIG. 1A, a calculation of a loss (e.g. a cross entropy loss), and a backward propagation from right to left in FIG. 1A through the network of the gradient of the loss. In the next cycle, each node takes into account the back propagated gradient to update the network parameters and produces a revised set of weights. In this way, the network can be trained to perform its desired operation (Y. LeCun, L. Bottou, G. B. Orr, and K.-R. Muller, “Efficient BackProp”, in Neural Networks: Tricks of the Trade, Springer, 2012).

In the processing of large datasets using neural networks, it is desirable to approximate functions. For example, there may be a need to approximate the activation function. Certain calculations involving the use of floating-point numbers may be carried out by a processing unit executing software instructions. Such calculations include the calculation of known functions, such as hyperbolic functions or logistic functions. These functions may be quite complex to calculate. In other circumstances, it may be desirable to sample random numbers according to a predetermined probability distribution function, for example to facilitate Monte Carlo sampling.

UK Patent Publication GB2580138A discusses techniques for approximating functions in hardware using a set of lookup tables (hereinafter LUTs) comprising entries comprising a value of the function in a particular range of input values, the range being referred to herein as the “interval” of the function. The function is divided into ranges; in one range a numerical approximation is applied, in another range one or more LUTs are used. The LUTs are prestored, meaning that the particular functions to be approximated must be defined in advance.

### SUMMARY

According to a first aspect of the disclosure, there is provided an execution unit configured to:
receive a first computer program instruction to populate a lookup table with a plurality of entries, each entry comprising an x value and corresponding y value representative of a point on a curve of the function, consecutive entries of the plurality of entries forming an interval of the function;
populate a lookup table stored in a local memory associated with the execution unit with the plurality of entries;
receive a second computer program instruction, the second computer program instruction indicating an input value;
determine, based on the lookup table, the interval of the function in which the input value falls; and
interpolate between y values of entries forming the interval to generate an output value corresponding to the input value.

The execution unit may be configured to perform linear interpolation between the y values of the entries forming the interval.

The first computer program instruction may have a field holding an indication of a memory address storing the plurality of entries. The indication may be an address in a data memory storing the plurality of entries, or a pointer to a register storing an address in a data memory, wherein the stored address in data memory stores the plurality of entries.

The plurality of entries may be ordered by their x values. The execution unit may be configured to compare the input value to x values of the lookup table. The execution unit may be configured to iterate through the x values of the lookup table, comparing the input value to the x values. An initial x value may be a smallest x value, and the execution unit may be configured to iterate through the x values from the smallest x value to a largest x value. The execution unit may be configured to determine the interval as the interval comprising: a first x value greater than the input value, and an x value immediately lower than the first x value. Alternatively, the initial value may be a largest x value, and the execution unit may be configured to iterate through the x values from the largest x value to a smallest x value. The execution unit may be configured to determine the interval as the interval comprising: a first x value smaller than the input value, and an x value immediately greater than the first x value.

The lookup table may have a storage capacity greater than a number of entries in the plurality of entries. The execution unit may be configured to terminate comparisons between input value(s) upon reaching a final entry of the plurality of entries stored in the lookup table. The execution unit may be configured to perform a predetermined maximum number of comparisons and/or interpolations to execute the second computer program instruction, wherein the predetermined maximum number corresponds to the number of comparisons and/or interpolations required to reach the final entry of the plurality of entries stored in the lookup table. The execution unit may be configured to perform a number of comparisons and/or interpolations K per execution cycle. The execution unit may be configured to perform a maximum number of execution cycles, wherein the maximum number of execution cycles corresponds to the maximum number of comparisons and/or interpolations divided by K. The execution unit may be configured to access a comparisons register storing the maximum number of execution cycles or the maximum number of comparisons and/or interpolations. The execution unit may be configured to execute a third computer program instruction to store the maximum number in the comparisons register.

The execution unit may be configured to set a size of the lookup table based on an operand of the first computer program instruction or a configuration value associated with the first computer program instruction.

The second computer program instruction may indicate an input vector comprising a plurality of input values. The execution unit may be configured to determine for each input value of the input vector, based on the lookup table, an interval of the function in which the respective input value falls. The execution unit may be configured to interpolate between y values forming each interval to generate an output value corresponding to each input value. The input vector may comprise one of two, four or eight input values.

The execution unit may comprise a mapping register to store an indication of input values in the input vector for which an output value has been generated. The execution unit may output an output vector comprising each output value when the mapping register indicates an output value has been generated for all input values. The mapping register may comprise a number of bits equal to a number of input values in the input vector. The execution unit may set a bit of the mapping register in response to the generation of an output value for an input value at a location of the input vector corresponding to the bit.

The execution unit may be configured to determine that the input value falls outside a domain of the function. The domain of the function may be defined by a smallest and a largest x value of the look up table. In response to the input value being smaller than the smallest x value, the execution unit may generate an output value corresponding to a y value of the smallest x value. In response to the input value being larger than the largest x value, the execution unit may generate an output value corresponding to a y value of the largest x value. In response to the input value being outside the domain, the execution unit may generate an output value corresponding to zero or NaN.

According to a second aspect of the disclosure, there is provided a processing unit comprising the execution unit defined in the first aspect. The processing unit may comprise local memory. The processing unit may be a tile processor.

The processing unit may be configured to execute a supervisor thread and a worker thread. The first computer program instruction may be executed as part of the supervisor thread. The second computer program instruction may be executed as part of the worker thread. The processing device may be configured to execute a computer program comprising the first computer program instruction and the second computer program instruction. The first computer program instruction may form part of an execution preamble of the computer program.

According to a third aspect of the disclosure, there is provided a processing device comprising a processing unit as defined in the second aspect. The processing device may comprise a plurality of processing units. At least one, but preferably all, of the processing units may comprise an execution unit as defined in the first aspect. The processing units may communicate via an exchange fabric which implements a time deterministic exchange.

According to a fourth aspect of the disclosure, there is provided a method implemented in an execution unit, the method comprising:
receiving a first computer program instruction to populate a lookup table with a plurality of entries, each entry comprising an x value and corresponding y value representative of a point on a curve of a function, consecutive entries of the plurality of entries forming an interval of the function;
populating a lookup table stored in local memory associated with the execution unit with the plurality of entries;
receiving a second computer program instruction, the second computer program instruction indicating an input value;
determining, based on the lookup table, the interval of the function in which the input value falls; and
interpolating between y values of entries forming the interval to generate an output value corresponding to the input value.

Further optional features of the method of the fourth aspect are defined hereinabove in relation to the first, second and third aspects, and may be combined in any combination.

According to a fifth aspect there is provided a computer program product comprising:
a first computer program instruction, which when executed by an execution unit, causes the execution unit to populate a lookup table stored in a local memory associated with the execution unit with a plurality of entries, each entry comprising an x value and corresponding y value representative of a point on a curve of a function, consecutive entries of the plurality of entries forming an interval of the function; and/or
a second computer program instruction indicating an input value, which when executed by the execution unit causes the execution unit to:
determine, based on the lookup table, the interval of the function in which the input value falls; and
interpolate between y values of entries forming the interval to generate an output value corresponding to the input value.

Further optional features of the method of the fourth aspect and computer program product of the fifth aspect are defined hereinabove in relation to the first, second and third aspects, and may be combined in any combination.

The disclosure also extends to a computer program product comprising instructions, which when executed, cause an execution unit to carry out any of the methods discussed herein. The disclosure also extends to a computer-readable medium, which may be non-transitory, storing instructions, which when executed, cause an execution unit to carry out any of the methods discussed herein.

### BRIEF DESCRIPTION OF THE DRAWINGS

For a better understanding of the present invention and to show how the same may be carried into effect, reference will now be made by way of example only to the accompanying drawings, in which:

FIG. 1A is a highly simplified schematic view of a neural network;

FIG. 1B is highly simplified schematic view of a neuron;

FIG. 2A is a schematic block diagram of a processor in which examples of the disclosure are implemented;

FIG. 2B is a schematic diagram of one example of a processor chip in which examples of the disclosure are implemented;

FIG. 3 is an illustration of an example function;

FIG. 4 is an example lookup table;

FIG. 5 is a schematic block diagram of an example execution unit; and

FIG. 6 is a schematic flowchart of an example method carried out in an execution unit.

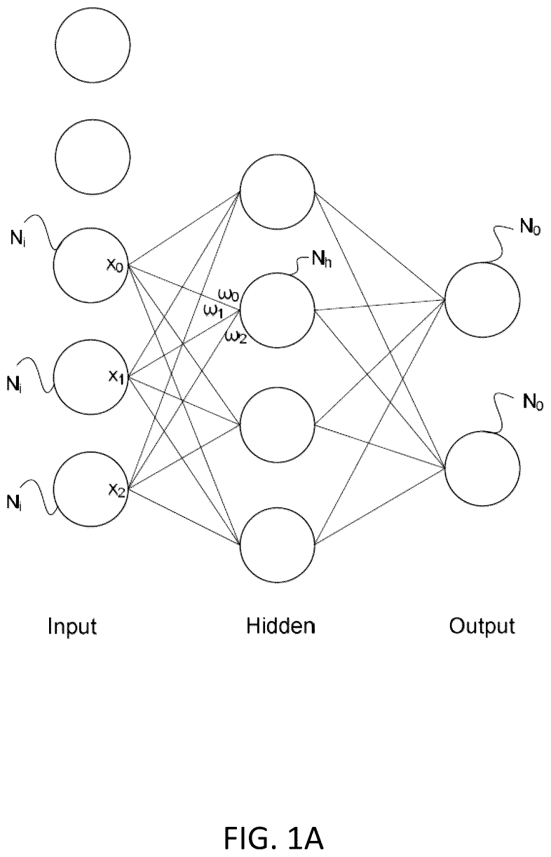

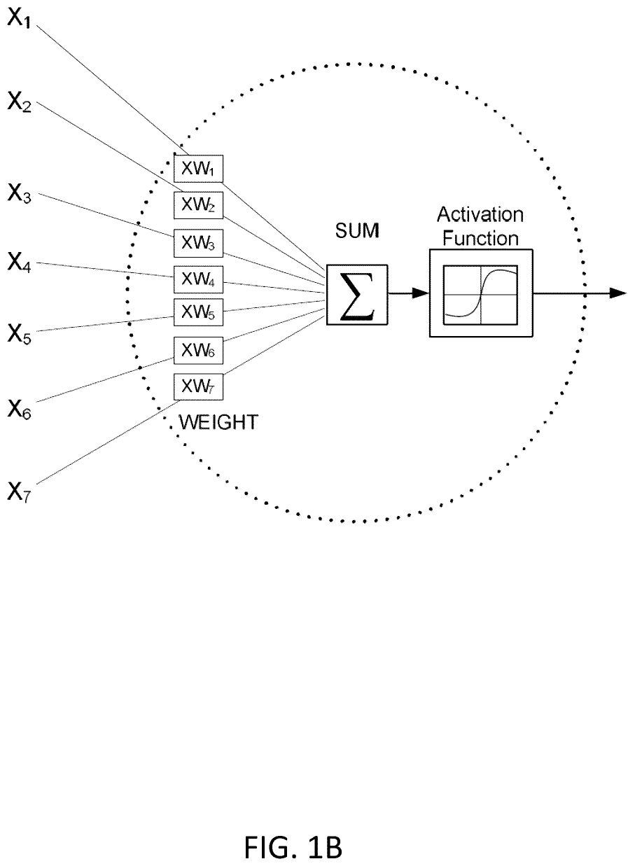

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various examples. Also, common but well-understood elements that are useful or necessary in a commercially feasible example are often not depicted in order to facilitate a less obstructed view of these various examples.

### DETAILED DESCRIPTION OF EXAMPLES

In overview, examples of the disclosure provide an instruction executable by an execution unit that enables population of a lookup table (LUT) by a programmer. This “populate” instruction allows the programmer to store values in the LUT that define intervals of the function. The LUT is held in memory associated with the execution unit (e.g. scratch memory). The populate instruction to store the values in the LUT may be executed as part of an execution preamble, for example by a supervisor thread executed by the execution unit.

Examples of the disclosure further provide an instruction that interpolates an output value for a received input value, based on values in the LUT. Accordingly, the execution unit can rapidly and efficiently calculate values, for example to approximate arbitrary functions.

Providing these instructions may also allow the programmer to produce values that suitably approximate the relevant function across a desired range of expected input values. Accordingly, the user, with relevant knowledge of the likely expected values in the context of the application can set up the LUT accordingly. Accordingly, large LUTs that cater for very wide ranges of input values can be avoided.

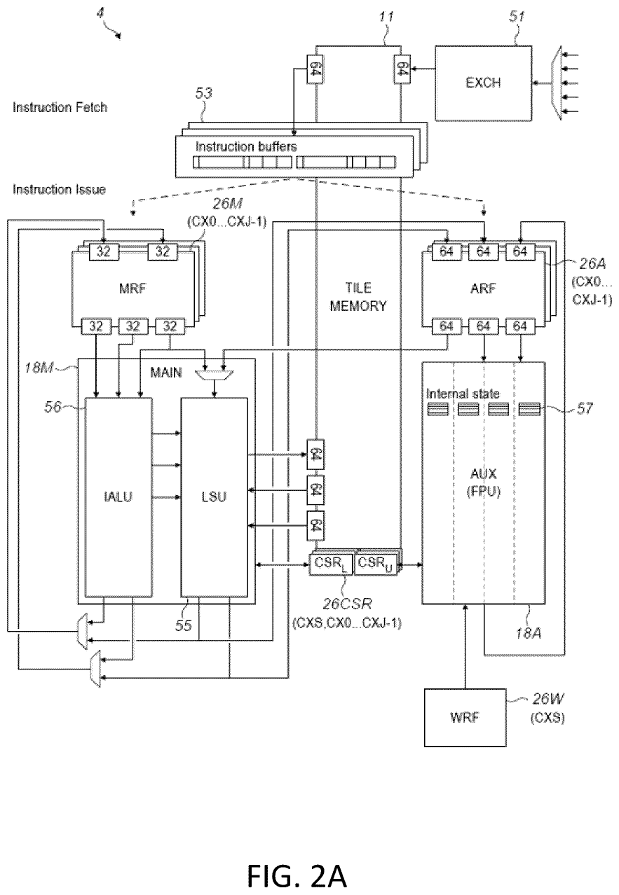

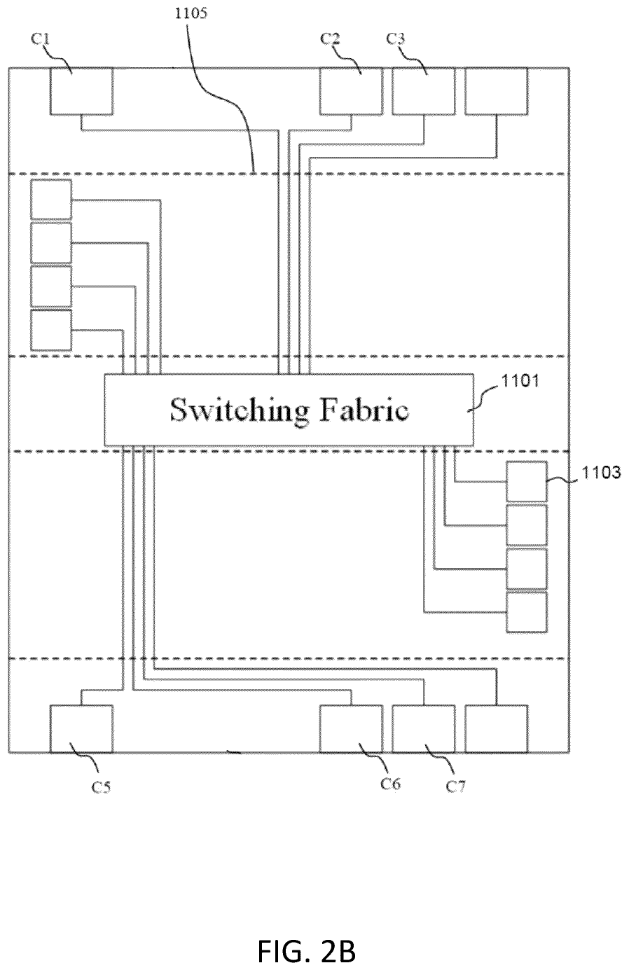

Examples are implemented in a processing unit, which may take the form of a processor 4, which is described in more detail with reference to FIG. 2A. In some examples, the processor 4 may take the form of a tile of a multi-tile processing device. An example of such a multiple tile processing device is described in more detail in our earlier application US patent application US 2020/0319861 A1, which is incorporated by reference.

Reference is made to FIG. 2A, which illustrates an example of the processor 4 including detail of the execution unit 18 and context registers 26. The processor 4 shown includes a weights register file 26W, and so may be specially adapted for machine learning applications, in which machine learning models are trained by adjusting the weights for those models. However, examples of the application are not limited to machine learning applications but are more broadly applicable. Furthermore, the processor 4 described is a multi-threaded processor capable of executing M threads concurrently. The processor 4 is able to support execution of M worker threads and one supervisor thread, where the worker threads perform arithmetic operations on data to generate results and the supervisor thread co-ordinates the worker threads and controls the synchronisation, sending and receiving functionality of the processor 4.

The processor 4 comprises a respective instruction buffer 53 for each of M threads capable of being executed concurrently. The context registers 26 comprise a respective main register file (MRF) 26M for each of M worker contexts and a supervisor context. The context registers further comprise a respective auxiliary register file (ARF) 26A for at least each of the worker contexts. The context registers 26 further comprise a common weights register file (WRF) 26W, which all the currently executing worker threads can access to read from. The WRF may be associated with the supervisor context in that the supervisor thread is the only thread that can write to the WRF. The context registers 26 may also comprise a respective group of control state registers 26CSR for each of the supervisor and worker contexts. The execution unit 18 comprises a main execution unit 18M and an auxiliary execution unit 18A. The main execution unit 18M comprises a load-store unit (LSU) 55 and an integer arithmetic logic unit (IALU) 56. The auxiliary execution unit 18A comprises at least a floating-point arithmetic unit (FPU).

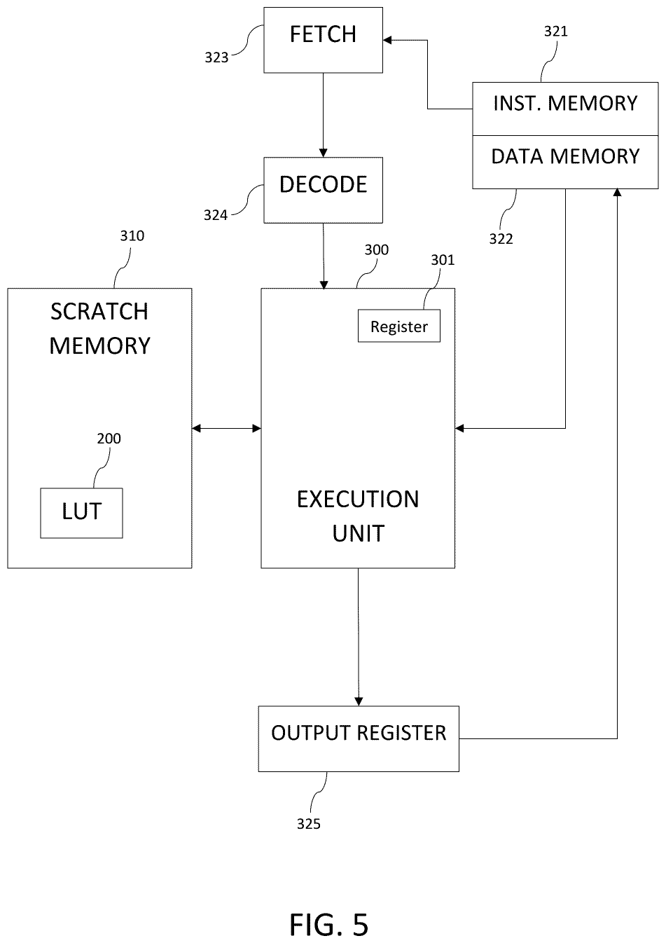

In each of the J interleaved time slots S0 . . . SJ−1, the scheduler controls a fetch stage (323, see FIG. 5) to fetch at least one instruction of a respective thread from the instruction memory 11, into the respective one of the J instruction buffers 53 corresponding to the current time slot. In examples, each time slot is one execution cycle of the processor, though other schemes are not excluded (e.g. weighted round-robin). In each execution cycle of the processor 4 (i.e. each cycle of the processor clock which clocks the program counter) the fetch stage 323 fetches either a single instruction or a small “instruction bundle” (e.g. a two-instruction bundle or four-instruction bundle), depending on implementation. Each instruction is then issued, via a decode stage (324, see FIG. 5) 16, into one of the LSU 55 or IALU 56 of the main execution unit 18M or the FPU of the auxiliary execution unit 18A, depending on whether the instruction (according to its opcode) is a memory access instruction, an integer arithmetic instruction or a floating point arithmetic instruction, respectively. The LSU 55 and IALU 56 of the main execution unit 18M execute their instructions using registers from the MRF 26M, the particular registers within the MRF 26M being specified by operands of the instructions. The FPU of the auxiliary execution unit 18A performs operations using registers in the ARF 26A and WRF 26W, where the particular registers within the ARF are specified by operands of the instructions. In examples the registers in the WRF may be implicit in the instruction type (i.e. pre-determined for that instruction type). The auxiliary execution unit 18A may also contain circuitry in the form of logical latches internal to the auxiliary execution unit 18A for holding some internal state 57 for use in performing the operations of one or more of the types of floating point arithmetic instruction.

In examples that fetch and execute instructions in bundles, the individual instructions in a given instruction bundle are executed simultaneously, in parallel down independent pipelines 18M, 18A (shown in FIG. 2A). In examples that execute bundles of two instructions, the two instructions may be executed simultaneously down respective auxiliary and main pipelines. In this case, the main pipeline is arranged to execute types of instruction that use the MRF and the auxiliary pipeline is used to execute types of instruction that use the ARF. The pairing of instructions into suitable complementary bundles may be handled by the compiler.

Each worker thread context has its own instance of the main register file (MRF) 26M and auxiliary register file (ARF) 26A (i.e. one MRF and one ARF for each of the barrel-threaded slots). Functionality described herein in relation to the MRF or ARF is to be understood to operate on a per context basis. However there is a single, shared weights register file (WRF) shared between the threads. Each thread can access the MRF and ARF of only its own context 26. However, all currently-running worker threads can access the common WRF. The WRF thus provides a common set of weights for use by all worker threads. In examples only the supervisor can write to the WRF, and the workers can only read from the WRF.

The instruction set of the processor 4 includes at least one type of load instruction whose opcode, when executed, causes the LSU 55 to load data from the data memory 22 into the respective ARF, 26A of the thread in which the load instructions was executed. The location of the destination within the ARF is specified by an operand of the load instruction. Another operand of the load instruction specifies an address register in the respective MRF, 26M, which holds a pointer to an address in the data memory (322, see FIG. 5) from which to load the data. The instruction set of the processor 4 also includes at least one type of store instruction whose opcode, when executed, causes the LSU 55 to store data to the data memory 322 from the respective ARF of the thread in which the store instruction was executed. The location of the source of the store within the ARF is specified by an operand of the store instruction. Another operand of the store instruction specifies an address register in the MRF, which holds a pointer to an address in the data memory 322 to which to store the data. In general the instruction set may include separate load and store instruction types, and/or at least one load-store instruction type which combines the load and store operations in a single instruction.

In response to the opcode of the relevant type of arithmetic instruction, the arithmetic unit (e.g. FPU) in the auxiliary execution unit 18A performs an arithmetic operation, as specified by the opcode, which comprises operating upon the values in the specified source register(s) in the threads' respective ARF and, optionally, the source register(s) in the WRF. It also outputs a result of the arithmetic operation to a destination register in the thread's respective ARF as specified explicitly by a destination operand of the arithmetic instruction.

The instruction set of the processor 4 also includes the populate and interpolate instructions discussed herein.

The processor 4 may also comprise an exchange interface 51 for exchanging data between the memory 11 and one or more other resources, e.g. other instances of the processor and/or external devices such as a network interface or network attached storage (NAS) device. As discussed above, in examples the processor 4 may form one of an array of interconnected processor tiles, each tile running part of a wider program. The individual processors 4 (tiles) thus form part of a wider processor or processing system 6. The tiles 4 may be connected together via an interconnect subsystem, to which they connect via their respective exchange interface 51. The tiles 4 may be implemented on the same chip (i.e. die) or on different chips, or a combination (i.e. the array may be formed from multiple chips each comprising multiple tiles 4). The interconnect system and exchange interface 51 may therefore comprise an internal (on-chip) interconnect mechanism and/or external (inter-chip) exchange mechanism, accordingly.

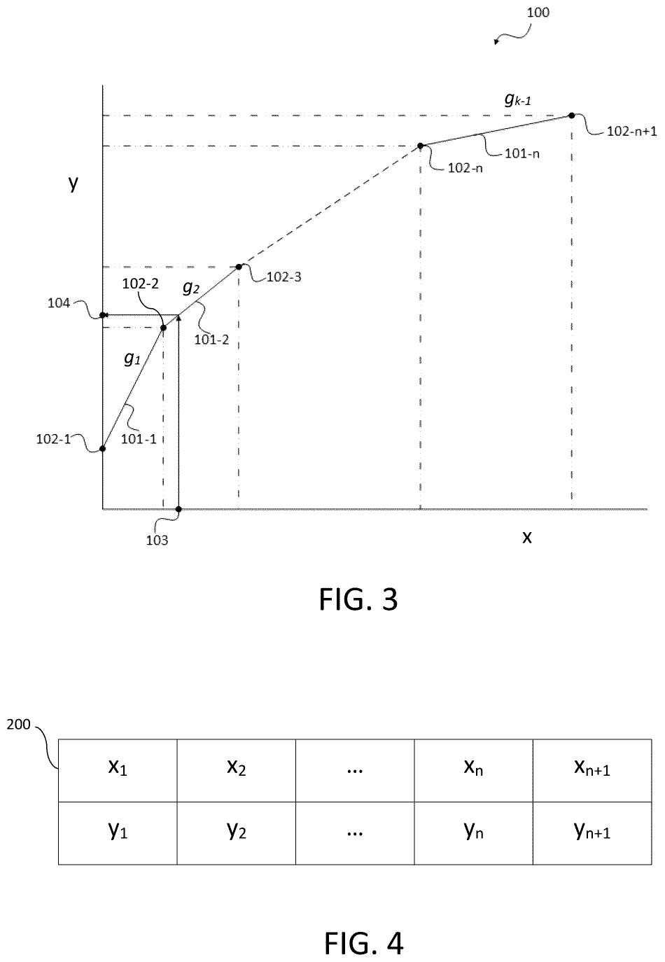

FIG. 3 illustrates an example function that may be approximated using the techniques discussed herein. As illustrated in FIG. 3, the curve 100 of a function ƒ that maps an input x value to an output y value may be represented by a series of n intervals 101-1, 101-2, . . . 101-n. Each interval forms a segment of the curve 100 and is defined by two points 102 on the curve 100 forming the boundaries of the interval 101. Each point is represented by an abscissa and an ordinate (i.e. an x coordinate and a y coordinate). For example, interval 101-1 is bounded by point 102-1 and point 102-2, interval 101-2 is bounded by points 102-2 and 102-3, and interval 101-n is bounded by points 102-n and 102-n+1. Accordingly, save for the first point 102-1 and last point 102-n+1, each point acts as the higher bound of the preceding interval and the lower bound of the subsequent interval.

To map an input value 103 to an output value 104, the x coordinates of the two points defining the interval in which the input falls are identified. The corresponding y values are then retrieved. The output value can then be calculated by interpolating between the y values. In the example shown in FIG. 3, the points 102-2 and 102-3 are those that bound the interval 101-2 containing the input value 103. Accordingly, the y values of these points are used for interpolation.

In one example, the interpolation between the points is linear. Accordingly, the overall interpolation technique may be considered a piecewise linear interpolation technique. In such an example, the interpolation technique may take into account only the y values bounding the identified interval. For example, in the case shown in FIG. 3, it may be that the y values of points 102-2 and 102-3 are sufficient to carry out the interpolation.

However, in other examples other interpolation techniques may be employed. For example, polynomial interpolation techniques such as cubic or Hermite interpolation may be used. In these examples and other examples, the interpolation techniques may take into account more of the points 102 on either side of the interval in order to calculate the interpolated output value that falls within the interval. For example, in the case shown in FIG. 3, the y values of points 102-1 and 102-4 may be taken into account. The interpolation may take into account two, three, four or any other number of points at either side of the interval 101-2 containing the input value 103. The number of points taken into account on each side of the interval 101-2 need not be the same. For example, this can be the case when the determined interval is between two points near the beginning or the end of the domain of the function.

Accordingly, discussion herein of interpolating between two values generally refers to generating an output that is based on the two values and falls therebetween. It does not imply that only the two values are used to compute the output.

FIG. 4 illustrates a lookup table (LUT) 200 that stores data to carry out the function approximation illustrated in FIG. 3. As shown the LUT 200 comprises a plurality of entries, comprising x values and corresponding y values. x1, y1 of the LUT 200 correspond to the x and y values of point 102-1, x2, y2 correspond to the x and y values of point 102-2 and so on. The entries in the LUT 200 are ordered by their x values, such that x1<x2, x2<x3, . . . , xn<xn+1.

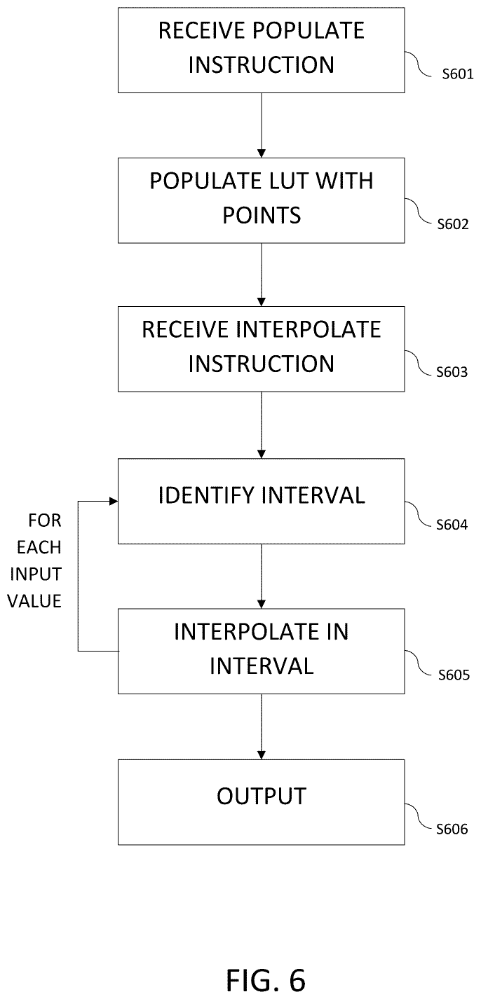

Turning now to FIGS. 5 and 6, the process of creating an LUT 200 by an execution unit 300 will now be discussed in detail. The execution unit 300 may correspond to the execution unit 18 discussed above in relation to FIG. 2A. Elements of the execution unit 18/300 not directly relevant to the present techniques have been omitted from FIG. 5 in the interests of simplicity and clarity.

As illustrated in FIG. 5, the execution unit 300 is associated with scratch memory 310 (also referred to as “scratchpad” memory). The scratch memory 310 is a local memory forming part of the processing unit 4. The memory 310 may be high-speed and may also be physically located close to the execution unit 300, or incorporated into the execution unit. In one example, the memory 310 is a register associated with the execution unit 300. For example, the memory 310 may be a context register 26 as discussed hereinabove.

In step S601 of FIG. 6, the execution unit 300 initially receives a first instruction to populate the LUT 200 (hereinafter referred to as a “populate” instruction). For example, the instruction memory 321 includes the populate instruction, which is then fetched by fetch stage 323, and then decoded by decode stage 324. The execution unit 300 then executes the decoded instruction. The populate instruction may not be a specific instruction for populating the LUT 200, but may instead be a more general memory store instruction capable of storing the LUT 200 in the scratch memory 310 when supplied with suitable operands or configuration values.

The populate instruction includes an indication of a location of the entries 102 that are to be used to populate the LUT 200 as an operand. For example, the instruction may comprise an address in data memory 322, or a pointer to a register (not shown) storing a memory address in data memory 322 that contains the points 102. In step S602, upon execution of the populate instruction, the execution unit 300 loads the points 102 from data memory 322 into the LUT 200.

Accordingly, the programmer may configure the LUT 200 with values representative of an arbitrary function, as part of a computer program executed by the execution unit 300. For example, the supervisor thread may issue the populate instruction. The instruction may form part of an execution preamble—i.e. an initial part of the program that sets up values for use in the main part of the program, for example to be subsequently executed by the worker threads. In such an example, the LUT 200 may then be shared by multiple worker threads. However, in alternative examples, each worker thread may populate and access its own LUT 200.

The particular configuration of the LUT 200 may be platform or implementation dependent.

In some examples, the size of the LUT 200 (i.e. how many points it is able to store) may be determined in advance (i.e. at the time of fabrication or configuration of the processing device). In such examples, a region of memory 310 of fixed, predetermined size may be allocated for the LUT 200 (and thus the entries of the LUT 200). In such an example, not all of the allocated memory (i.e. not all of the entries in the LUT 200) may be populated. Unpopulated entries may be set to zero or NaN, or contain values set by previous uses of the memory 310.

In other examples, the size of the LUT 200 may be set by the programmer, for example using an operand or configuration data associated with the populate instruction. In such examples, the size of the LUT 200 is set to be equal to the number of entries to be stored.

The precision of the points may also be determined in advance. Example precisions of the points may for example be FP32, FP16, BF16 or FP8, but it is to be understood that these are merely examples.

Subsequently, in step S603 the execution unit 300 receives a second instruction to provide output values corresponding to received input values, based on the LUT 200. The instruction may be referred to herein as the interpolate or “interp” instruction.

The interpolate instruction may comprise an indication of the input values as an operand. For example, the instruction may comprise an address in data memory 322, or a pointer to a register (not shown) storing a memory address in data memory 322 that contains the input values. The input values may take the form of a vector of input values.

The interpolate instruction may be issued by a worker thread. The interpolate instruction may form part of a computer program, such as a computer program that trains a neural network.

In one example, the interpolate instruction takes the following format:
f<n>v<m>interp $aDest, $aSrc
   where n represents the number of bits of the input values and m represents the size of the input vector. Example values of n may include 32 bits for full precision, 16 bits for half precision, 8 bits for quarter precision floating point values. Example values of m may include 2, 4 or 8. The operands $aDest and $aSrc respectively represent memory locations where the output of the instruction is to be stored and where the input is stored.

In step S604, for a first input value of the input vector, the interval containing the input value is identified. In order to identify the interval containing the input value, the execution unit 300 performs successive comparisons between the input value and the x values in the LUT 200, starting at the first entry x1. In other words, the execution unit 300 iterates through the x values of the LUT 200. As the x values in the LUT are ordered by increasing input value, the comparisons end when the first x value is identified that is greater than the input value. The interval containing the input value is then identified as the interval between the first x value greater than the input value xᵢ and the preceding x value in the LUT 200 xᵢ₋₁.

In some examples, the execution unit 300 may alternatively iterate from the final entry (xn+1) through progressively smaller x values towards x1. In this example, the comparisons end when the first x value is identified that is smaller than the input value. The interval containing the input value is then identified as the interval between the first x value smaller than the input value xᵢ and the succeeding x value in the LUT 200 xᵢ₊₁. This effectively corresponds to notionally iterating left from the righthand side of the LUT 200, as opposed to iterating right from the lefthand side as described above.

In step S605, the execution unit 300 retrieves the y values yᵢ₋₁, yᵢ corresponding to the x values forming the interval. The execution unit 300 then interpolates between the y values to generate an output value corresponding to the input value. The interpolation may be linear interpolation, or any other interpolation technique including those discussed above.

In some circumstances, the first input value is equal to an x value. In one example, the execution unit 300 outputs the corresponding y value, and no interpolation is required. However, this approach may require an extra comparison as to whether the input value is equal to the x value, in addition to greater than (or less than in the alternative example), in order to cater for a case that may be relatively rare. Accordingly, in some circumstances, the execution unit 300 may instead be configured to not check whether the input value is equal to an x value, and instead simply apply the relevant interpolation technique. In such examples, the comparison during the iteration may be whether the x value is greater than or equal to (or less than or equal to in the alternative example).

The steps S604 and S605 may be carried out for each of the subsequent input values in the input vector. In one example, the steps S604 and S605 may be repeated successively for each input value in the input vector.

However, in another example, step S604 may be first be carried out for each value of the input vector. That is to say, each input value is compared to x1, each input value is then compared to x2, and so on to identify the intervals corresponding to each of the input values. This approach may minimise the number of times the memory storing the LUT is accessed. The comparisons for a particular input value stop when the interval has been identified. Subsequently, the interpolation S605 is then carried out for each input value in relation to each identified interval.

Once all of the values in the input vector have been mapped to a corresponding output value, the execution unit 300 outputs the output values in step S606. For example, the execution unit 300 stores the output values in output register 325, whereupon they are stored at the destination address in the data memory 322. This completes the execution of the interpolate instruction.

In some examples, some or all of the interpolate instruction may be implemented in dedicated hardware. For example, the execution unit 300 may comprise specific circuitry to carry out the comparisons in order to identify the interval (i.e. step S604), or to interpolate within the interval once identified (i.e. step S605), or both. In some examples, the interpolate instruction may make use of existing hardware, for example in the FPU.

Returning to steps S604 and S605 in more detail, for an LUT 200 having size N (i.e. N entries), if the execution unit 300 able to perform K comparisons or interpolations in an execution cycle of the processing device comprising the execution unit 300, the maximum number of cycles required to identify the interval and generate the output for a given input vector of width M is equal to P=N/K. As discussed above, M and N may be platform or implementation dependent. Similarly, K may also depend on the platform or implementation of the execution unit 300 and/or processing device 4 more generally.

This maximum number of cycles P is effectively the worst-case scenario in which at least one of the input values in the input vector falls into the final interval. In examples where the input value does not correspond to that worst-case scenario, the number of cycles required to compute the output will be less than P. Of course, it is not known a priori how many cycles will actually be required to provide the output.

In one example, to allow the instruction to be executed in a deterministic manner (i.e. in a predetermined time), the processing device 4 may allow only one instruction/input vector to occupy the processing pipeline at a time. In other words, the execution unit 300 operates that it will take P cycles to produce M outputs.

In another example, the execution unit 300 may be configured to store information indicative of which inputs in the input vector have been mapped to an output. For example, the execution unit 300 may be associated with (e.g. comprise) an M-bit register 301, wherein a bit of the register 301 is set by the execution unit when the corresponding input value of the input vector has been mapped to an output value. Accordingly, once all bits of the register 301 are set, the execution unit 300 outputs the vector of output values. The execution unit 300 then increments the program counter. In this example, execution of the interpolation instruction only occupies as many execution cycles as are actually required to carry out the interpolation.

As discussed above, in some examples the size of the LUT 200 may be determined in advance, and thus have a particular fixed capacity that cannot be changed at runtime. In such examples, in some cases, the size of the LUT 200 may be larger than the number of intervals that the user specifies to model the function. In other words, the LUT 200 size N may be greater than the number of points 102 the user defines to model the function. In such an example, some entries in the LUT 200 are left empty.

To account for this situation, the execution unit 300 may be configured to execute a maximum number of cycles. The maximum number of cycles corresponds to the number of (x, y) pairs stored in the LUT 200 divided by K. This causes the comparisons to stop after the last (x, y) pair stored in the LUT 200 has been reached. For example, a register (e.g. a context register 26 such as control and status register 26CSR) may store the maximum number of cycles. The value in the register may be set by the programmer (i.e. by another computer program instruction).

It will be appreciated that in some examples the input value may be outside the function domain. In other words, it may be the case that the input value is smaller than the smallest x value x1, or larger than the largest value xn+1 in the LUT 200. In such cases, the execution unit 300 may be configured to deal with the out of domain input value in one of a number of ways. For example, input values smaller than x1 may be treated as being equal to x1, and input values larger than xn+1 may be treated as being equal to xn+1. In other examples, the execution unit may return zero or NaN for input values smaller than x1 and/or greater than xn+1. In some examples, user (i.e. the programmer) may specify how input values falling outside the function domain are handled, for example by selecting one of the above options. This may be achieved by setting a control register associated with the instruction with suitable configuration values, from which a value representative of the option is read. Alternatively, the option may be an operand of the instruction.

In typical examples, the domain is [0,1]. In other words, x1 will be 0 and xn+1 will be 1.

In some examples, each interval 101 is assigned to a thread. That is to say, the step of interpolating between the values defining a particular interval may be the responsibility of a corresponding thread. For example, there may be n threads, each corresponding to a respective one of n intervals 101. In some circumstances, the intervals 101 are non-uniform—for example shorter intervals 101 may be used to model regions of steeper slopes in the curve. In such circumstances, if the input is a vector of uniformly distributed values, some intervals (i.e. wider intervals) will correspond to more of the input values. In other words, the input values would not be uniformly distributed amongst the threads. This may result in differing execution times of the threads, and consequently may require reordering of the output values.

Various alterations may be made to the above-described examples within the scope of the present disclosure. For example, the interpolate instruction may be applied to single input values rather than vectors comprising a plurality of input values. In other examples, the context register may store a maximum number of comparisons, rather than a maximum number of cycles. Although the examples have been discussed in the context of a tile processor 4, it will be understood that this is merely one example of a suitable processing device incorporating an execution unit 300 as defined herein.

A further discussion of multi-tile processing units now follows. As discussed above, the processor 4 may form part of a multi-tile processing device. There are many possible different manifestations of a suitable processing device, which may take the form of a chip. Graphcore have developed an intelligence processing unit (IPU) which is described for example in US patent applications numbers: US 2019/0121387 A1; US 2019/0121388 A1; US 2019/0121777 A1; US 2020/0319861 A1 the contents of which are herein incorporated by reference. FIG. 2B is a highly schematic diagram of an IPU. The IPU comprises a plurality of tiles 1103 on a silicon die, each tile comprising a processing unit (e.g. the processing unit 4 described above) with local memory. The tiles communicate with each other using a time deterministic exchange. A switching fabric 1101 (sometimes referred to as an exchange or exchange fabric) is connected to each of the tiles by the respective sets of output wires and connectable to each of the tiles by their respective sets of input wires via switching circuitry controllable by each tile. A synchronisation module (not shown) is operable to generate a synchronisation signal to switch between a compute phase and an exchange phase. The tiles execute their local programs in the compute phase according to a common clock which may be generated on the die or received by the die. At a predetermined time in the exchange phase, a tile may execute a send instruction from its local program to transmit a data packet onto its output set of connection wires, the data packet being destined for at least one recipient tile but having no destination identifier identifying that recipient tile. At a predetermined switch time, the recipient tile executes a switch control instruction from its local program to control the switching circuitry to connect its inputs set of wires to the switching fabric to receive the data packet at a receive time. The transmit time at which the data packet is scheduled to be transmitted from the transmitting tile, and the predetermined switch time, are governed by the common clock with respect to a synchronisation signal.

The time deterministic exchange allows for efficient transfer between the tiles on the die. Each tile has its own local memory which provides the data storage and the instruction storage. As described herein, the IPU is additionally connected to external memory from which data may be transferred onto the IPU for use by the tiles via the fabric chips.

The tiles 1103 of the IPU may be programmed such that a data packet that is transmitted by a SEND instruction from their local program is intended either to access memory (a memory access packet) or to have at its destination another IPU which is connected in the cluster or system. In those cases, the data packet is transmitted onto the switching fabric by the originating tile 1103, but is not picked up by recipient tile within the IPU. Instead, the switching fabric causes the tile to be provided to the appropriate connector C1, C2 etc. for external communication from the IPU. The packet intended for off-chip communication is generated to include information which defines its final off-chip destination but not the external port from which it is to be transmitted. The packet may be transmitted to the external port using the principles of the time deterministic exchange to identify the external port for the packet when code is compiled for the tiles. For example, a memory access packet may identify a memory address. A packet intended for another IPU may include the identifier of the other IPU. This information is used by the routing logic on the fabric chip to correctly route the off-chip packets generated by the IPU.

The diagram in FIG. 2B shows five exemplary regions of the exemplary IPU chip, separated by four boundaries 1105, represented by dashed lines. Note that the dashed lines represent abstract boundaries 1105 of abstract regions on the processor chip, shown for illustrative purposes; the boundaries 1105 do not necessarily represent physical boundaries on an IPU chip.

1. An execution unit configured to:
receive a first computer program instruction to populate a lookup table with a plurality of entries, each entry comprising an x value and corresponding y value representative of a point on a curve of a function, consecutive entries of the plurality of entries forming an interval of the function;
populate a lookup table stored in a local memory associated with the execution unit with the plurality of entries;
receive a second computer program instruction, the second computer program instruction indicating an input value;
determine, based on the lookup table, the interval of the function in which the input value falls; and
interpolate between y values of entries forming the interval to generate an output value corresponding to the input value.

2. The execution unit of claim 1, further configured to perform linear interpolation between the y values of the entries forming the interval.

3. The execution unit of claim 1, wherein the first computer program instruction comprises a field holding an indication of a memory address storing the plurality of entries.

4. The execution unit of claim 1, wherein:
the plurality of entries are ordered by their x values;
the execution unit is configured to iterate through the x values of the lookup table to determine the interval.

5. The execution unit of claim 4, wherein the execution unit is configured to:
iterate through the x values from a smallest x value to a largest x value; and
the execution unit is configured to determine the interval as the interval comprising: a first x value greater than the input value and an x value immediately lower than the first x value.

6. The execution unit of claim 4, wherein the execution unit is configured to:
iterate through the x values from a largest x value to a smallest x value; and
the execution unit is configured to determine the interval as the interval comprising: a first x value smaller than the input value and an x value immediately greater than the first x value.

7. The execution unit of claim 4, wherein:
the lookup table has a storage capacity greater than a number of entries in the plurality of entries, and
the execution unit is configured to terminate comparisons between input value upon reaching a final entry of the plurality of entries stored in the lookup table.

8. The execution unit of claim 7, wherein the execution unit is configured to perform a predetermined maximum number of comparisons and/or interpolations, wherein the predetermined maximum number corresponds to the number of comparisons and/or interpolations required to reach the final entry of the plurality of points stored in the lookup table.

9. The execution unit of claim 1, wherein the execution unit is further configured to set a size of the lookup table based on an operand of the first computer program instruction or a configuration value associated with the first computer program instruction.

10. The execution unit of claim 1, wherein:
the second computer program instruction indicates an input vector comprising a plurality of input values;
the execution unit is configured to determine for each input value of the input vector, based on the lookup table, an interval of the function in which the respective input value falls; and
the execution unit is configured to interpolate between y values forming each interval to generate an output value corresponding to each input value.

11. The execution unit of claim 10, comprising a mapping register to store an indication of input values in the input vector for which an output value has been generated, wherein the execution unit is configured to output an output vector comprising each output value when the mapping register indicates an output value has been generated for all input values.

12. The execution unit of claim 1, wherein:
in response to the input value being smaller than a smallest x value, the execution unit is configured to generate an output value corresponding to a y value of the smallest x value; and/or
in response to the input value being larger than a largest x value, the execution unit is configured to generate an output value corresponding to a y value of the largest x value.

13. The execution unit of claim 1, wherein:
in response to the input value being smaller than a smallest x value, the execution unit is configured to generate an output value corresponding to zero or NaN;
in response to the input value being larger than a largest x value, the execution unit is configured to generate an output value corresponding to zero or NaN.

14. A processing unit comprising an execution unit and a local memory, wherein the execution unit is configured to:
receive a first computer program instruction to populate a lookup table with a plurality of entries, each entry comprising an x value and corresponding y value representative of a point on a curve of a function, consecutive entries of the plurality of entries forming an interval of the function;
populate a lookup table stored in the local memory associated with the execution unit with the plurality of entries;
receive a second computer program instruction, the second computer program instruction indicating an input value;
determine, based on the lookup table, the interval of the function in which the input value falls; and
interpolate between y values of entries forming the interval to generate an output value corresponding to the input value.

15. The processing unit of claim 14, wherein:
the processing unit is configured to execute a supervisor thread and a worker thread;
the first computer program instruction is executed as part of the supervisor thread;
the second computer program instruction is executed as part of the worker thread.

16. The processing unit of claim 14, wherein the processing unit is configured to execute a computer program comprising the first computer program instruction and the second computer program instruction.

17. A method implemented in an execution unit, the method comprising:
receiving a first computer program instruction to populate a lookup table with a plurality of entries, each entry comprising an x value and corresponding y value representative of a point on a curve of a function, consecutive entries of the plurality of entries forming an interval of the function;
populating a lookup table stored in local memory associated with the execution unit with the plurality of entries;
receiving a second computer program instruction, the second computer program instruction indicating an input value;
determining, based on the lookup table, the interval of the function in which the input value falls; and
interpolating between y values of entries forming the interval to generate an output value corresponding to the input value.

18. A computer program product comprising:
a first computer program instruction, which when executed by an execution unit, causes the execution unit to populate a lookup table stored in a local memory associated with the execution unit with a plurality of entries, each entry comprising an x value and corresponding y value representative of a point on a curve of a function, consecutive entries of the plurality of entries forming an interval of the function; and/or
a second computer program instruction indicating an input value, which when executed by the execution unit causes the execution unit to:
determine, based on the lookup table, the interval of the function in which the input value falls; and
interpolate between y values of entries forming the interval to generate an output value corresponding to the input value.
